(19) United States
(12) Patent Application Publication
(10) Pub. No.: US 2026/0159093 A1
(43) Pub. Date: Jun. 11, 2026

(54) APPARATUS AND METHOD FOR CONTROLLING VEHICLE

(71) Applicants: Hyundai Motor Company, Seoul (KR); Kia Corporation, Seoul (KR)

(72) Inventors: Seul Ki JEON, Hwaseong-Si (KR); Hui Won SHIN, Hwaseong-Si (KR); Eung Hwan KIM, Hwaseong-Si (KR)

(21) Appl. No.: 19/272,329

(22) Filed: Jul. 17, 2025

(30) Foreign Application Priority Data
Dec. 5, 2024 (KR) 10-2024-0179905

(51) Int. Cl. B60W 40/08; B60W 50/00; B60W 50/14

(52) U.S. Cl. CPC B60W 40/08; B60W 50/0098; B60W 50/14; B60W 2040/0836; B60W 2050/0083; B60W 2050/143; B60W 2050/146; B60W 2540/18; B60W 2540/24

(57) ABSTRACT

An apparatus of a vehicle may comprise a processor and a memory storing at least one instruction that, when executed by the processor communicating with the memory, is configured to cause the apparatus to detect, using a sensor installed on a steering wheel of the vehicle, an alcohol level associated with exhaled air of a driver of the vehicle, determine, based on the detected alcohol level and the sensor being located within a threshold driver exhalation area range after the driver being seated in the vehicle, an intoxicated state of the driver, determine an alcohol detection mode based on the intoxicated state of the driver and sensor location, detect a second alcohol level, and update the intoxicated state of the driver accordingly.

### CROSS-REFERENCE TO RELATED APPLICATION

This application claims the benefit of priority to Korean Patent Application No. 10-2024-0179905, filed in the Korean Intellectual Property Office on Dec. 5, 2024, the entire contents of which are incorporated herein by reference.

### TECHNICAL FIELD

The present disclosure relates to an apparatus and a method for controlling a vehicle, and more particularly, to an apparatus and a method for controlling a vehicle capable of improving the detection accuracy of an alcohol sensor.

### BACKGROUND

The matters described in this Background section are only for enhancement of understanding of the background of the disclosure, and should not be taken as acknowledgment that they correspond to prior art already known to those skilled in the art.

In order to fundamentally prevent drunk driving of a driver, an alcohol sensor may be used to check whether the driver has been drinking when a driver gets into a vehicle, and driving may be prohibited when the driver is drunk.

An alcohol sensor may be provided on a steering wheel to obtain the exhaled air of a driver most closely. However, because the steering wheel is rotatable, the alcohol sensor also may change depending on the rotation angle of the steering wheel.

Therefore, when the exhaled air of a driver may be obtained while the steering wheel is turned, the alcohol sensor may not accurately detect the exhalation components, and may not able to accurately determine whether the driver is drunk.

In some cases, the alcohol sensor may fail to detect alcohol in the driver's exhaled air when the steering wheel is turned, even if the driver is actually intoxicated. In such cases, the driver may be mistakenly permitted to drive. Therefore, a technology is considered to accurately determine a driver's drunken state during and after the initiation of vehicle operation, regardless of the steering wheel position.

### SUMMARY

The present disclosure has been made to solve the above-mentioned problems.

An apparatus of a vehicle, the apparatus may comprise a processor, and a memory storing at least one instruction that, when executed by the processor communicating with the memory, is configured to cause the apparatus to detect, using a sensor installed on a steering wheel of the vehicle, an alcohol level associated with exhaled air of a driver of the vehicle, determine, based on the detected alcohol level and the sensor being located within a threshold driver exhalation area range after the driver being seated in the vehicle, an intoxicated state of the driver, determine an alcohol detection mode based on the intoxicated state of the driver indicating the driver not intoxicated and permitted to drive and based on whether the sensor being within the threshold driver exhalation area range, detect, based on the determined alcohol detection mode, a second alcohol level associated with exhaled air of the driver, and update, based on the detected second alcohol level, the intoxicated state of the driver.

The apparatus, wherein the at least one instruction, when executed by the processor communicating with the memory, is configured to cause the apparatus to determine, based on a steering angle change amount of the steering wheel not exceeding a threshold value, that the sensor is located in the threshold driver exhalation area range.

The apparatus, wherein the at least one instruction, when executed by the processor communicating with the memory, is configured to cause the apparatus to determine that the sensor is out of the threshold driver exhalation area range before the driver starts driving, and output a guidance message requesting an operation of the steering wheel to allow the sensor to be located within the threshold driver exhalation area range.

The apparatus, wherein the at least one instruction, when executed by the processor communicating with the memory, is configured to cause the apparatus to update the intoxicated state of the driver by re-determining whether the sensor is located within the threshold driver exhalation area range after the driving is permitted.

The apparatus, wherein the at least one instruction, when executed by the processor communicating with the memory, is configured to cause the apparatus to determine, based on a setting mode of the driver, the alcohol detection mode.

The apparatus, wherein the at least one instruction, when executed by the processor communicating with the memory, is configured to cause the apparatus to determine the alcohol detection mode as a first mode, based on the setting mode of the driver corresponding to a continuous measurement mode, and control, based on the first mode, the sensor and air conditioning of the vehicle.

The apparatus, wherein the at least one instruction, when executed by the processor communicating with the memory, is configured to cause the apparatus to determine the alcohol detection mode as a second mode, based on the setting mode of the driver corresponding to a precision measurement mode, and control, based on the second mode, the sensor and air conditioning of the vehicle.

The apparatus, wherein the at least one instruction, when executed by the processor communicating with the memory, is configured to cause the apparatus to based on a setting mode of the driver and the sensor being out of the threshold driver exhalation area range after the driving is permitted, determine the alcohol detection mode.

The apparatus, wherein the at least one instruction, when executed by the processor communicating with the memory, is configured to cause the apparatus to determine the alcohol detection mode as a third mode, based on the setting mode of the driver corresponding to a continuous measurement mode, and control, based on the third mode, the sensor and air conditioning of the vehicle.

The apparatus, wherein the at least one instruction, when executed by the processor communicating with the memory, is configured to cause the apparatus to determine the alcohol detection mode as a fourth mode, wherein the setting mode of the driver corresponds to a precision measurement mode, and control, based on the fourth mode, the sensor and air conditioning of the vehicle.

A method performed by a vehicle, the method may comprise after a driver sitting in a seat of the vehicle, determining, based on an alcohol level detected by a sensor of the vehicle, an intoxicated state of the driver, wherein the sensor is installed on a steering wheel and located within a threshold driver exhalation area range, determining, based on the intoxicated state of the driver indicating the driver not intoxicated and permitted to drive and based on whether the sensor being located within the threshold driver exhalation area range, an alcohol detection mode, detecting, based on the determined alcohol detection mode, a second alcohol level associated with exhaled air of the driver, and updating, based on the detected second alcohol level, the intoxicated state of the driver.

The method may further comprise determining, based on a steering angle change amount of the steering wheel not exceeding a threshold value, that the sensor is located in the threshold driver exhalation area range.

The method may further comprise determining that the sensor is out of the threshold driver exhalation area range before the driver starts driving, and outputting a guidance message requesting an operation of the steering wheel to allow the sensor to be located within the threshold driver exhalation area range.

The method, wherein the updating of the intoxicated state of the driver may comprise re-determining whether the sensor is located within the threshold driver exhalation area range after the driving is permitted.

The method, wherein the determining of the alcohol detection mode may comprise determining, based on a setting mode of the driver, the alcohol detection mode.

An apparatus of a vehicle, the apparatus may comprise a processor, and a memory storing at least one instruction that, when executed by the processor communicating with the memory, is configured to cause the apparatus to determine, based on a driver sitting in a seat of the vehicle and a driver-selected setting mode, whether an alcohol sensor of the vehicle is positioned within a predetermined breath sensing region, control, based on the driver-selected setting mode and whether the alcohol sensor of the vehicle is positioned within the predetermined breath sensing region, one or more operating parameters of the alcohol sensor, detect an alcohol level associated with exhaled air of the driver using the alcohol sensor with the controlled operating parameters, output, based on the detected alcohol level, a signal indicating a state of the driver, and control, based on the signal, operation of the vehicle.

The apparatus, wherein the at least one instruction, when executed by the processor communicating with the memory, is configured to cause the apparatus to determine that the alcohol sensor is positioned within the predetermined breath sensing region and that the driver-selected setting mode corresponds to a first detection mode, and control a suction strength of the alcohol sensor and an air conditioning of the vehicle to maintain respective previously set configurations for alcohol detection.

The apparatus, wherein the at least one instruction, when executed by the processor communicating with the memory, is configured to cause the apparatus to determine that the alcohol sensor is positioned within the predetermined breath sensing region and that the driver-selected setting mode corresponds to a second detection mode, control the alcohol sensor to increase a suction strength of the alcohol sensor for alcohol detection, and shut off an air conditioning of the vehicle for alcohol detection.

The apparatus, wherein the at least one instruction, when executed by the processor communicating with the memory, is configured to cause the apparatus to determine that the alcohol sensor is not positioned within the predetermined breath sensing region and that the driver-selected setting mode corresponds to a third detection mode, control the alcohol sensor to increase a suction strength of the alcohol sensor for alcohol detection, and control an air conditioning of the vehicle to reduce an airflow output of the air conditioning for alcohol detection.

The apparatus, wherein the at least one instruction, when executed by the processor communicating with the memory, is configured to cause the apparatus to determine that the alcohol sensor is not positioned within the predetermined breath sensing region and that the driver-selected setting mode corresponds to a fourth detection mode, and disable the alcohol sensor and control an air conditioning of the vehicle to maintain a previously set airflow output of the air conditioning such that alcohol detection is deferred until the alcohol sensor is subsequently positioned within the predetermined breath sensing region.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an apparatus for controlling a vehicle according to an example of the present disclosure;

FIG. 2 shows an example of a breathing direction of a driver according to one example of the present disclosure;

FIG. 3 shows an example of a case where an alcohol sensor according to an example of the present disclosure is located in a normal measurement area;

FIG. 4 and FIG. 5 show an exemplary case where an alcohol sensor according to an example of the present disclosure is not located in a normal measurement area;

FIG. 6, FIG. 7, FIG. 8, and FIG. 9 show exemplary guidance messages output in situations where guidance is required for a driver according to an example of the present disclosure;

FIG. 10 shows an example of a method of controlling a vehicle according to an example of the present disclosure; and

FIG. 11 shows an exemplary computing system for executing a method according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is specified by the identical numeral even when they are displayed on other drawings. Further, in describing the example of the present disclosure, a detailed description of the related known configuration or function will be omitted when it is determined that it interferes with the understanding of the example of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of adaptive alcohol detection based on sensor position and a detection mode) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of adaptive alcohol detection based on sensor position and a detection mode) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of adaptive alcohol detection based on sensor position and a detection mode) described herein. Minimum risk maneuver (MRM) operation(s) may also be controlled, for example, based on one or more features (e.g., features of adaptive alcohol detection based on sensor position and a detection mode) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of adaptive alcohol detection based on sensor position and a detection mode) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of adaptive alcohol detection based on sensor position and a detection mode) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of adaptive alcohol detection based on sensor position and a detection mode) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

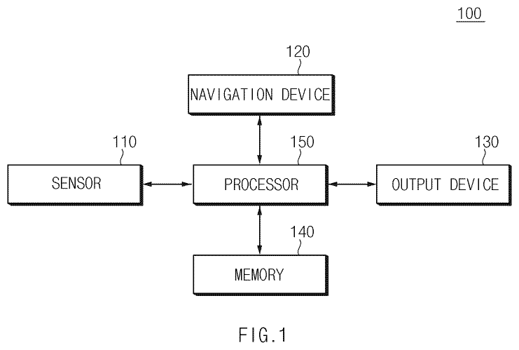

FIG. 1 shows an example of an apparatus for controlling a vehicle according to an example of the present disclosure.

As illustrated in FIG. 1, an apparatus 100 for controlling a vehicle may include a sensor 110, a navigation device 120, an output device 130, a memory 140, and a processor 150.

The sensor 110 may include an alcohol sensor that detects alcohol in the breath of a driver. According to an example, the sensor 110 may be provided at the lower center of a steering wheel to easily detect the breath of the driver. In addition, the sensor 110 may be provided near a cluster (e.g., a digital instrument panel, a dashboard module, or a display-integrated housing, etc.) or at one side of a door (e.g., a door trim panel, a door handle recess, or a pillar cover, etc.).

In addition, the sensor 110 may include a steering angle sensor that detects the steering angle of the steering wheel. According to an example, the steering angle of the steering wheel may be detected based on vehicle state data obtained by using an acceleration sensor and a wheel speed sensor (e.g., a yaw rate sensor, a lateral acceleration sensor, or a vehicle dynamics controller, etc.).

The navigation device 120, which is equipped with a GPS receiver to receive the current location of the vehicle, may provide map image information of a specified area, route guidance image information, route guidance voice information, vehicle speed information, destination information, steering direction prediction, and the like based on the current location of the vehicle. In addition, the navigation device 120 may provide a route to the destination (e.g., highway paths, local roads, or suggested detours, etc.). The navigation device 120 may provide various information related to the operation of the navigation device 120 to the user through the output device 130.

The output device 130 may output an image or sound under control of the processor 150. According to an example, the output device 130 may be implemented as a display device or a sound output device. In this case, the display device may include a HUD, a cluster, and the like (e.g., center console display, digital instrument panel, or rearview mirror display, etc.). According to an example, the display device may be implemented as a display employing a liquid crystal display (LCD) panel, a light emitting diode (LED) panel, an organic light emitting diode (OLED) panel, or the like. The display device may be implemented as a touch screen panel (TSP) or a gesture-based interface.

The memory 140 may store at least one algorithm for performing calculations or execution of various commands for operations of an apparatus for controlling a vehicle according to an example of the present disclosure. According to an example, the memory 140 may store at least one command executed by the processor 150, and the command may cause an apparatus for controlling a vehicle according to the present disclosure to operate. The memory 140 may include at least one storage medium (e.g., a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, or an optical disk, etc.).

The processor 150 may be implemented with various processing devices in which a semiconductor chip or equivalent circuitry capable of performing operations or executions of various commands is embedded, and may control operations of an apparatus for controlling a vehicle according to an example of the present disclosure. The processor 150 may be electrically connected to the sensor 110, the navigation device 120, the output device 130, and the memory 140 through a wired cable (e.g., CAN bus, LVDS, or Ethernet, etc.) or various circuits to transmit electrical signals including control commands and the like, and may execute operations or data processing related to control and/or communication. The processor 150 may include at least one of a central processing unit, an application processor, a communication processor (CP), or a combination thereof (e.g., a system-on-chip integrating all three).

The processor 150 may determine a setting mode of the driver if the driver sits in the vehicle seat (e.g., upon detecting door closure, seat occupancy, or ignition signal, etc.). According to an example, the processor 150 may output a guidance message to select a mode for measuring the alcohol level of the driver if the driver sits in the vehicle seat. According to an example, the processor 150 may output a guidance message to select one of a continuous measurement mode and a precision measurement mode as the mode for measuring the alcohol level, and when the driver selects one of the continuous measurement mode and the precision measurement mode, the processor 150 may determine the setting mode of the driver based on the selected information. According to an example, the continuous measurement mode may mean a mode in which the alcohol measurement is attempted even if the alcohol sensor is not located in a normal measurement area (e.g., within a threshold driver exhalation area range), and the precision measurement mode may mean a mode in which the alcohol measurement is attempted only if the alcohol sensor is located in the normal measurement area (e.g., within the threshold driver exhalation area range).

When determining the setting mode of the driver, the processor 150 may enter an alcohol measurement standby mode, for example, to monitor the positioning of the alcohol sensor and vehicle conditions relevant to alcohol sensing (e.g., steering alignment, air conditioning state, or door status, etc.).

When entering the alcohol measurement standby mode, the processor 150 may determine whether the alcohol sensor is located in the normal measurement area (e.g., within the threshold driver exhalation area range). According to an example, the processor 150 may determine whether the alcohol sensor is located within a preset driver exhalation area, for example, based on a steering angle, position offset, or alignment window defined relative to the driver's seated position.

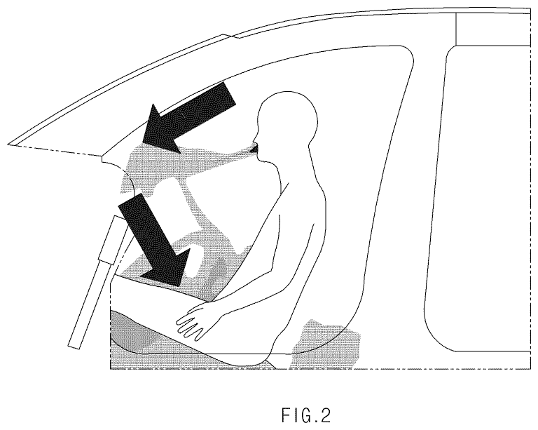

Hereinafter, the operation of the processor 150 for determining whether the alcohol sensor is located within the normal measurement area (preset driver exhalation area) will be described with reference to FIGS. 2 to 5, which show exemplary airflow paths and positioning scenarios based on steering angle and driver breath flow direction.

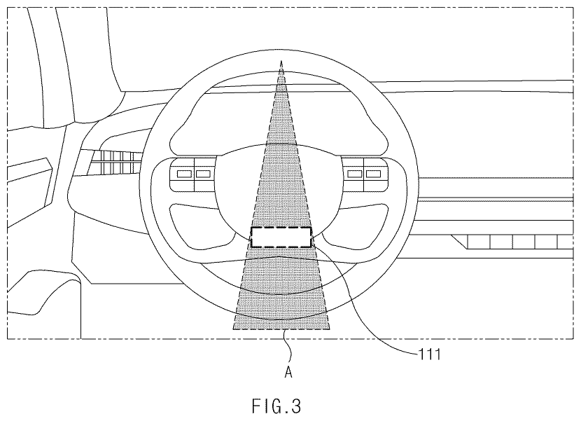

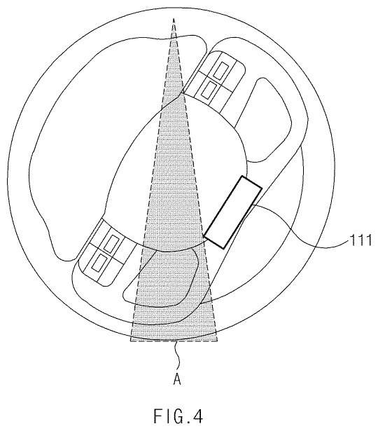

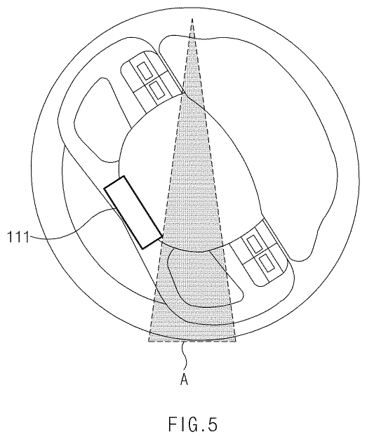

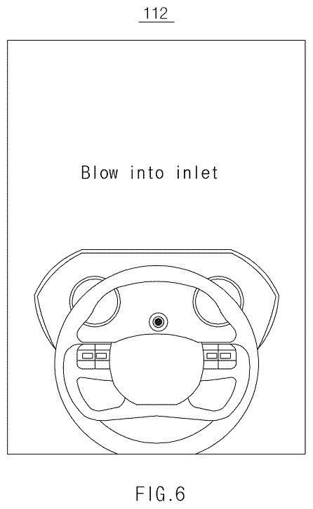

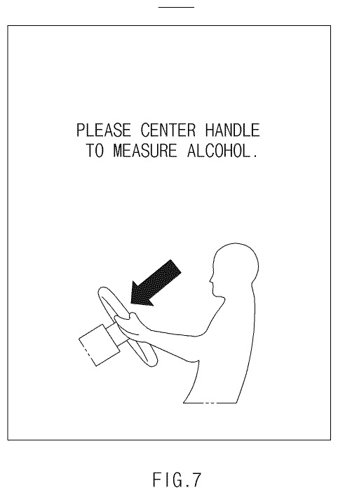

FIG. 2 shows an example of a breathing direction of a driver according to one example of the present disclosure. FIG. 3 shows an example of a case where an alcohol sensor according to an example of the present disclosure is located in a normal measurement area (e.g., within a threshold driver exhalation area range). FIGS. 4 and 5 show an exemplary case where an alcohol sensor according to an example of the present disclosure is not located in a normal measurement area (e.g., not within a threshold driver exhalation area range, for example, if the steering wheel is significantly turned or offset from center, etc.).

As illustrated in FIG. 2, the exhaled air from the driver contains carbon dioxide, which flows downward toward the driver's face (e.g., or driver's face and upper body). Accordingly, as illustrated in FIG. 3, the processor 150 may set a specified area that becomes wider from the top to the bottom of the steering wheel as an exhalation area ‘A’ of the driver (e.g., a vertically expanding triangular zone originating from the driver's mouth, etc.).

As illustrated in FIG. 3, the processor 150 may determine that an alcohol sensor 111 is located within the exhalation area ‘A’ of the driver if the steering wheel is not rotated (steering angle change amount is 0 (zero) degrees) or if the steering angle change amount is less than a threshold (e.g., ±15 degrees, etc.). According to an example, the processor 150 may determine that the alcohol sensor 111 is located within the normal measurement area (e.g., within a threshold driver exhalation area range) if the alcohol sensor 111 is located within the exhalation area ‘A’ of the driver.

As illustrated in FIGS. 4 and 5, the processor 150 may determine that the alcohol sensor 111 is not located within the exhalation area ‘A’ of the driver if the steering wheel is rotated and the steering angle change amount exceeds a threshold value (e.g., during active left or right turns, etc.). According to an example, the processor 150 may determine that the alcohol sensor 111 is not located within the normal measurement area (e.g., within a threshold driver exhalation area range) if the alcohol sensor 111 is not located within the exhalation area ‘A’ of the driver.

When entering the measurement standby mode, the processor 150 may determine whether the alcohol sensor is located in the normal measurement area (e.g., within a threshold driver exhalation area range). The processor 150 may enter the alcohol measurement mode if it determines that the alcohol sensor is located within a threshold driver exhalation area range and vehicle conditions are suitable (e.g., door closed, airflow suppressed, and steering angle stabilized, etc.).

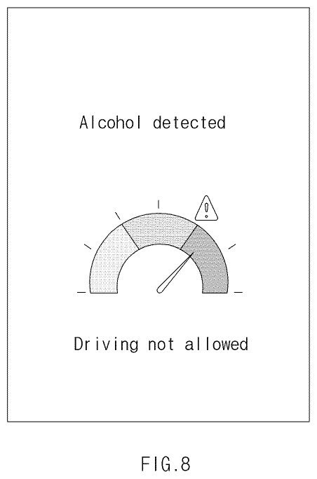

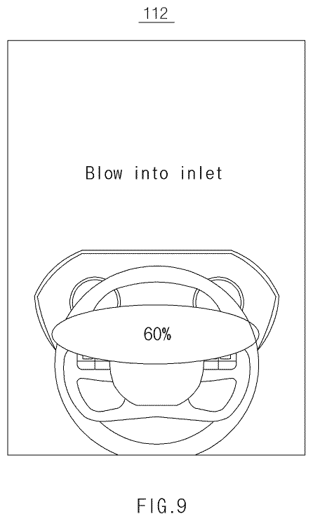

The processor 150 may output a guidance message through the output device 130 depending on a situation in which guidance is required for the driver (e.g., improper sensor positioning, insufficient exhalation, or steering misalignment, etc.). Guidance messages according to an example refer to FIG. 6, FIG. 7, FIG. 8, and FIG. 9.

FIG. 6, FIG. 7, FIG. 8, and FIG. 9 show exemplary guidance messages output in situations where guidance is required for a driver according to an example of the present disclosure (e.g., text-based prompts, progress indicators, or breath volume feedback, etc.).

As illustrated in FIG. 6, when entering the alcohol measurement mode, the processor 150 may measure alcohol in the exhaled air of the driver. When entering the alcohol measurement mode, the processor 150 may output a guidance message (e.g., “Blow into inlet”) as shown in FIG. 6 or alternatively or additionally other guidance messages (e.g., “Measuring . . . . Please exhale steadily,” or “Remain still during detection,” etc.).

if it is determined that the alcohol sensor is not located in the normal measurement area (e.g., within a threshold driver exhalation area range), the processor 150 may output a message for guiding the alcohol sensor to be located in the normal measurement area (e.g., within the threshold range) and control the air conditioning. According to an example, a guidance message such as “Please align the handle to the center for alcohol measurement” may be output as shown in FIG. 7 (or other messages such as “Rotate steering wheel slightly left” or “Adjust your posture for accurate measurement,” etc.).

In addition, if it is determined that the alcohol sensor is not located in the normal measurement area (e.g., within a threshold driver exhalation area range), the processor 150 may control the air conditioning in accordance with the setting mode of the driver.

According to an example, the processor 150 may control the air conditioning to adjust the airflow direction if the setting mode of the driver is set to the continuous measurement mode. For example, if the steering wheel is turned to the right, the processor 150 may control the left-side air conditioning weakly or temporarily shut off right-side vents, such that the influence of the air conditioning on the alcohol measurement of the alcohol sensor is reduced or minimized because the alcohol sensor is located to the left with respect to the driver seat (e.g., near the instrument cluster or steering wheel spoke, etc.).

Because the alcohol sensor is controlled to be turned off if the setting mode of the driver is set to the precision measurement mode, the processor 150 may control the air conditioning in the previously set mode (e.g., resume prior vent intensity, airflow direction, or HVAC temperature settings, etc.).

When the processor 150 enters the alcohol measurement mode and measures alcohol in the exhaled air of the driver, the processor 150 may determine whether the alcohol detection amount exceeds a threshold value (e.g., 0.14 mg/L, etc.). If the alcohol detection amount exceeds the threshold value, an alcohol re-measurement mode may be entered, for example, to verify the accuracy of the detected result.

When entering the alcohol re-measurement mode, the processor 150 may enter the re-measurement mode and count the number of times alcohol is re-measured (e.g., up to a predefined limit such as three attempts, etc.). If the number of re-measurements exceeds a threshold number, the processor 150 may determine that it is impossible to drive the vehicle. If it is determined that it is impossible to drive the vehicle, the processor 150 may control the ignition to be turned off, thereby preventing driving. According to an example, as illustrated in FIG. 8, a message informing that alcohol is detected and driving is blocked may be output (“Alcohol detected. Driving not allowed”).

If it is determined that the alcohol detection amount does not exceed the threshold value (e.g., the detection amount is below the threshold value), the processor 150 may determine whether the door is open (e.g., to confirm whether the same person remains in the driver's seat, etc.).

When determining that the door is open, the processor 150 may determine that a proxy measurer gets off after measuring alcohol and may re-enter the alcohol measurement mode. The processor 150 determines that driving is possible if the alcohol detection amount does not exceed the threshold value and the door is not opened (e.g., the same occupant remains seated throughout the process).

the processor 150 may measure an amount of exhaled air for measuring alcohol in the exhaled air of the driver, and if the amount of exhaled air for measuring alcohol is insufficient to measure alcohol, the processor 150 may output a message indicating that the amount of exhaled air is insufficient (e.g., “Please exhale longer” or “Insufficient breath detected,” etc.). According to an example, as illustrated in FIG. 9, the processor 150 may output the amount of exhaled air measured as a percentage (e.g., “60% exhalation detected” or a visual bar graph). If it is determined that the amount of exhaled air is insufficient, the processor 150 may enter the re-measurement mode to prompt another attempt.

The processor 150 may determine an emergency situation if there is a request from the driver due to an emergency situation or there is an emergency situation in which alcohol measurement is not performed (e.g., medical emergency, fire risk, or system fault, etc.). The processor 150 may enter a bypass mode when determining that there is an emergency situation. When entering the bypass mode, the processor 150 may be switched to a drivable state even if alcohol measurement is not performed. When entering the bypass mode and driving, the processor 150 may store driving information in the memory (e.g., event timestamp, user ID, bypass reason code, etc.).

The processor 150 may enter a mode for re-determining a drunken state or intoxicated state of the driver if driving starts and a preset cycle arrives (e.g., after a fixed distance, elapsed time, or stop event, etc.).

According to an example, the processor 150 may determine whether there is information about the route to a destination set in the navigation device 120 (e.g., turn-by-turn guidance, active route preview, or ETA calculation, etc.).

If it is determined that there is information about the route to a destination set by the driver, the processor 150 may determine whether the vehicle drives straight based on road information (e.g., curvature information, heading angles, or GPS-derived trajectory, etc.).

If it is determined that the vehicle drives straight, the processor 150 may determine that the alcohol sensor is located in the normal measurement area (e.g., within a threshold driver exhalation area range) because the steering wheel is not rotated.

If it is determined that the alcohol sensor is located in the normal measurement area (e.g., within a threshold driver exhalation area range), the processor 150 may determine an alcohol detection mode according to the setting mode of the driver, and detect alcohol in the determined alcohol detection mode to re-determine the drunken state of the driver.

The processor 150 may determine the alcohol detection mode as the first mode if the setting mode of the driver is the continuous measurement mode, and may control the alcohol sensor and vehicle air conditioning to correspond to the first mode (e.g., enabling fan operation and adjusting airflow direction to allow detection even if steering position is not optimal).

According to an example, if the alcohol sensor is located in the normal measurement area (e.g., within a threshold driver exhalation area range) and the setting mode of the driver is the continuous measurement mode, the processor 150 may control the suction strength of the alcohol sensor and the vehicle air conditioning to maintain the previously set mode (e.g., medium fan speed, standard vent configuration, or default detection cycle, etc.).

The processor 150 may determine the alcohol detection mode as the second mode if the setting mode of the driver is the precision measurement mode, and control the alcohol sensor and vehicle air conditioning to correspond to the second mode (e.g., stricter airflow control and higher detection fidelity, etc.).

According to an example, if the alcohol sensor is located in the normal measurement area (e.g., within a threshold driver exhalation area range) and the setting mode of the driver is the precision measurement mode, the processor 150 may control the suction strength of the alcohol sensor to be set to be “strong” (e.g., increasing a current suction strength or setting to the maximum strength) and the vehicle air conditioning to be “off”. If the setting mode of the driver is the precision measurement mode, the processor 150 may determine to attempt alcohol measurement only if the alcohol sensor is located in the normal measurement area (e.g., within a threshold driver exhalation area range), and may set the suction strength of the alcohol sensor to be “strong” (e.g., increasing a current suction strength or setting to the maximum strength) and control the vehicle air conditioning to be “off” such that alcohol measurement is easily performed without external airflow interference.

If it is determined that the vehicle does not drive straight, the processor 150 may determine that the vehicle is in a right turn state or a left turn state (e.g., based on real-time steering sensor data or navigation curvature profiles, etc.).

If it is determined that the vehicle is in a right-turn or left-turn state, the processor 150 may determine that the steering wheel is rotated beyond a specified angular deviation.

According to an example, the processor 150 may determine whether the amount of change in the steering angle exceeds a threshold value based on curvature information of a left turn road or a right turn road (e.g., derived from map data or heading vector changes, etc.). According to an example, the processor 150 may determine whether the amount of change in the steering angle exceeds a threshold value based on information obtained by the steering angle sensor even if no destination is set and thus no path information exists (e.g., by using real-time angle deviation thresholds such as ±30 degrees, etc.).

If it is determined that the amount of change in the steering angle of the steering wheel does not exceed a threshold value, the processor 150 may determine that the alcohol sensor is located in the normal measurement area (e.g., within a threshold driver exhalation area range).

According to an example, if it is determined that the alcohol sensor is located in the normal measurement area (e.g., within a threshold driver exhalation area range), the processor 150 may determine the alcohol detection mode according to the setting mode of the driver, and detect alcohol in the determined alcohol detection mode to re-determine the drunken state of the driver.

If it is determined that the steering wheel is rotated and the amount of change in the steering angle exceeds a threshold, the processor 150 may determine that the alcohol sensor is not located in the normal measurement area (e.g., within a threshold driver exhalation area range).

According to an example, if it is determined that the alcohol sensor is not located within the normal measurement area (e.g., within a threshold driver exhalation area range), the processor 150 may determine an alcohol detection mode according to the setting mode of the driver, and detect alcohol in the determined alcohol detection mode to re-determine the drunken state of the driver.

The processor 150 may determine the alcohol detection mode as the third mode if the setting mode of the driver is the continuous measurement mode, and control the alcohol sensor and vehicle air conditioning to correspond to the third mode (e.g., override environmental conditions and continue measurement attempts, etc.).

According to an example, if the alcohol sensor is not located in the normal measurement area (e.g., within a threshold driver exhalation area range) and the setting mode of the driver is the continuous measurement mode, the processor 150 may set the suction strength of the alcohol sensor to be “strong” (e.g., increasing a current suction strength or setting to the maximum strength) and control the vehicle air conditioning to be “weak” (e.g., reducing a current airflow output of the vehicle air conditioning or setting an airflow output of the vehicle air conditioning to the minimum level). If the setting mode of the driver is the continuous measurement mode, the processor 150 may determine that alcohol measurement is attempted even if the alcohol sensor is not located in the normal measurement area (e.g., within a threshold driver exhalation area range), and may set the suction strength of the alcohol sensor to be “strong” (e.g., increasing a current suction strength or setting to the maximum strength) and control the vehicle air conditioning to be “weak” (e.g., reducing a current airflow output of the vehicle air conditioning or setting an airflow output of the vehicle air conditioning to the minimum level) such that alcohol measurement is easily performed even if the alcohol sensor is not located in an optimal position relative to the exhalation flow (e.g., within a threshold driver exhalation area range).

If the setting mode of the driver is the precision measurement mode, the processor 150 may determine the alcohol detection mode as a fourth mode and control the sensor and vehicle air conditioning to correspond to the fourth mode (e.g., enabling detection only under strictly defined spatial and airflow conditions, etc.).

According to an example, if the alcohol sensor is not located in the normal measurement area (e.g., not within the threshold driver exhalation area range) and the setting mode of the driver is the precision measurement mode, the processor 150 may set the alcohol sensor to be “off” and control the vehicle air conditioning to maintain the previously set mode (e.g., unchanged fan level or airflow direction). If the setting mode of the driver is the precision measurement mode, the processor 150 may determine to attempt alcohol measurement only if the alcohol sensor is located within the threshold range, and because the alcohol sensor is not located within that range, the alcohol sensor may be turned off and alcohol measurement may not be performed, so the vehicle air conditioning may be controlled in the preset mode to prevent false readings or unnecessary airflow disruptions.

The processor 150 may measure alcohol in the determined alcohol detection mode and determine whether to maintain driving based on the amount of alcohol detected. The processor 150 may determine the alcohol detection mode based on whether the sensor is located within the threshold driver exhalation area range, periodically even after driving has started, measure alcohol, and determine whether to maintain driving, thereby fundamentally preventing drunk or intoxicated driving by performing ongoing validation checks during vehicle operation.

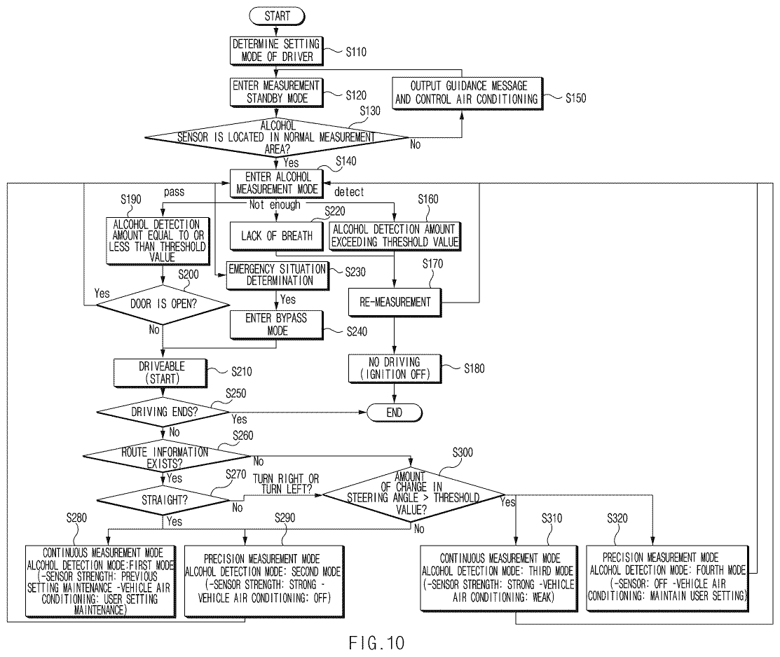

FIG. 10 shows an example of a method of controlling a vehicle according to an example of the present disclosure and corresponds to the logic performed by the processor 150 in various sensing and control stages.

As illustrated in FIG. 10, in S110, the processor 150 may determine a setting mode of the driver if the driver sits in the vehicle seat (e.g., through ignition-on signal or seat occupancy detection, etc.).

According to an example, the processor 150 may output a guidance message to select a mode for measuring the alcohol level of the driver if the driver sits in the vehicle seat. According to an example, the processor 150 may output a guidance message to select one of a continuous measurement mode and a precision measurement mode as the mode for measuring the alcohol level, and if the driver selects one of the continuous measurement mode and the precision measurement mode, the processor 150 may determine the setting mode of the driver based on the selected information. According to an example, the continuous measurement mode may mean a mode in which the alcohol measurement is attempted even if the alcohol sensor is not located within the threshold driver exhalation area range, and the precision measurement mode may mean a mode in which the alcohol measurement is attempted only if the alcohol sensor is located within the threshold range.

When determining the setting mode of the driver, the processor 150 may enter an alcohol measurement standby mode in S120 to prepare for detection by checking sensor positioning and environmental readiness.

When entering the alcohol measurement standby mode, the processor 150 may determine whether the alcohol sensor is located within the threshold driver exhalation area range in S130. According to an example, the processor 150 may determine whether the alcohol sensor is located within a preset driver exhalation area (e.g., based on a range of steering angles or predefined alignment zone geometry, etc.).

In S140, the processor 150 may enter the alcohol measurement mode if it determines that the alcohol sensor is located within the threshold driver exhalation area range. According to an example, when entering the alcohol measurement mode, the processor 150 may measure alcohol in the exhaled air of the driver. When entering the alcohol measurement mode, the processor 150 may output a guidance message (“Blow into inlet”) as shown in FIG. 6 (e.g., alternatively or additionally, a visual indicator showing “Breath detection in progress” or progress percentage bar, etc.).

If it is determined that the alcohol sensor is not located within the threshold driver exhalation area range, in S150, the processor 150 may output a message for guiding the alcohol sensor to be located within the threshold range and control the air conditioning. According to an example, a guidance message such as “Please align the handle to the center for alcohol measurement” may be output as shown in FIG. 7 (or alternative prompts such as “Adjust steering position to continue” or “Center wheel for detection,” etc.).

In S150, if it is determined that the alcohol sensor is not located within the threshold driver exhalation area range, the processor 150 may control the air conditioning according to the setting mode of the driver. According to an example, the processor 150 may control the air conditioning to adjust the airflow direction if the setting mode of the driver is set to the continuous measurement mode. For example, if the steering wheel is turned to the right, the processor 150 may control the left-side air conditioning weakly (e.g., reduce vent output or close the vent temporarily) such that the influence of the air conditioning on the alcohol measurement of the alcohol sensor is minimized because the alcohol sensor is located to the left with respect to the driver seat (e.g., on the left spoke or cluster bezel).

Because the alcohol sensor is controlled to be turned off if the setting mode of the driver is set to the precision measurement mode, the processor 150 may control the air conditioning in the previously set mode (e.g., maintaining original airflow intensity, temperature, or distribution settings).

The processor 150 may enter the alcohol measurement mode and measure alcohol in the exhaled air of the driver, and if it is determined in S160 that the alcohol detection amount exceeds a threshold value (e.g., a legally defined breath alcohol concentration), the processor 150 may enter the alcohol re-measurement mode in S170, for example, to verify the result before disabling driving.

When entering the alcohol re-measurement mode, the processor 150 may enter the re-measurement mode and count the number of times alcohol is re-measured (e.g., by incrementing a retry counter stored in memory). If the number of re-measurements exceeds a threshold number, in S180, the processor 150 may determine that it is impossible to drive the vehicle. If it is determined that it is impossible to drive the vehicle, the processor 150 may control the ignition to be turned off, thereby preventing driving. According to an example, as illustrated in FIG. 8, a message informing that alcohol is detected and driving is blocked may be output (e.g., “Drive disabled due to alcohol detection” or “Re-measurement failed. Ignition locked,” etc.).

If it is determined in S190 that the alcohol detection amount does not exceed the threshold value (e.g., below the threshold value), in S200, the processor 150 may determine whether the door is open (e.g., based on input from a door status sensor).

When determining that the door is open, in S140, the processor 150 may determine that a proxy measurer (e.g., a different individual who is not the intended driver) gets off after measuring alcohol and may re-enter the alcohol measurement mode. In S210, the processor 150 determines that driving is possible if the alcohol detection amount is equal to or less than the threshold value and the door is not opened (indicating the same person remains in the vehicle).

the processor 150 may measure an amount of exhaled air for measuring alcohol in the exhaled air of the driver, and if the amount of exhaled air for measuring alcohol is insufficient to measure alcohol, the processor 150 may output a message indicating that the amount of exhaled air is insufficient (e.g., “Please exhale more strongly” or “Insufficient breath detected,” etc.). According to an example, as illustrated in FIG. 9, the processor 150 may output the amount of exhaled air measured as a percentage (e.g., “60%” “Breath strength: 40%” or “Breath level: 70%—keep exhaling,” etc.). If it is determined in S220 that the amount of exhaled air is insufficient, the processor 150 may enter the re-measurement mode in S170.

in S230, the processor 150 may determine an emergency situation if there is a request from the driver due to an emergency situation (e.g., via pressing an emergency override button or selecting an emergency mode on a screen) or there is an emergency situation in which alcohol measurement is not performed (e.g., medical issue, system fault, or failed sensor initialization, etc.). In S240, the processor 150 may enter a bypass mode when determining that there is an emergency situation. When entering the bypass mode, the processor 150 may be switched to a drivable state even if alcohol measurement is not performed. When entering the bypass mode and driving, the processor 150 may store driving information in the memory (e.g., time, location, and reason for bypass).

The processor 150 may enter a mode for re-determining a drunken state of the driver if driving starts and a preset cycle arrives (e.g., every 15 minutes or upon certain driving conditions such as idling or low-speed cruising).

The processor 150 may determine whether driving ends in S250, and if it determines that driving does not end, in S260, the processor 150 may determine whether there is route information to the destination set in the navigation device 120 (e.g., whether the navigation system is actively guiding a set route).

If it is determined that there is information about the route to a destination set by the driver, in S270, the processor 150 may determine whether the vehicle drives straight based on road information (e.g., curvature information, heading angle stability, or continuous low steering angle change).

If it is determined that the vehicle drives straight, the processor 150 may determine that the alcohol sensor is located within the threshold driver exhalation area range because the steering wheel is not rotated (e.g., close to its neutral or center position).

If it is determined that the alcohol sensor is located within the threshold driver exhalation area range, the processor 150 may determine an alcohol detection mode according to the setting mode of the driver, and detect alcohol in the determined alcohol detection mode to re-determine the drunken state of the driver.

In S280, the processor 150 may determine the alcohol detection mode as the first mode if the setting mode of the driver is the continuous measurement mode, and may control the alcohol sensor and vehicle air conditioning to correspond to the first mode (e.g., maintain airflow and continue measuring even during minor misalignment).

According to an example, if the alcohol sensor is located within the threshold driver exhalation area range and the setting mode of the driver is the continuous measurement mode, the processor 150 may control the suction strength of the alcohol sensor and the vehicle air conditioning to maintain the previously set mode (e.g., default fan strength and sensor sensitivity remain unchanged).

In S290, the processor 150 may determine the alcohol detection mode as the second mode if the setting mode of the driver is the precision measurement mode, and control the alcohol sensor and vehicle air conditioning to correspond to the second mode (e.g., stricter alignment and airflow cutoff).

According to an example, if the alcohol sensor is located within the threshold driver exhalation area range and the setting mode of the driver is the precision measurement mode, the processor 150 may control the suction strength of the alcohol sensor to be set to be “strong” and the vehicle air conditioning to be “off”. If the setting mode of the driver is the precision measurement mode, the processor 150 may determine to attempt alcohol measurement only if the alcohol sensor is located within the threshold range, and may set the suction strength of the alcohol sensor to be “strong” and control the vehicle air conditioning to be “off” such that alcohol measurement is easily performed (e.g., by reducing external airflow interference and increasing sensor sensitivity).

If it is determined that the vehicle does not drive straight, the processor 150 may determine that the vehicle is in a right turn state or a left turn state (e.g., based on steering angle deviation from center position).

According to an example, in S300, the processor 150 may determine whether the amount of change in the steering angle exceeds a threshold value based on curvature information of a left turn road or a right turn road (e.g., road segment turning radius or navigation-derived angle). According to an example, the processor 150 may determine whether the amount of change in the steering angle exceeds a threshold value based on information obtained by the steering angle sensor even if no destination is set and thus no path information exists (e.g., in free driving without route guidance).

If it is determined that the amount of change in the steering angle of the steering wheel does not exceed a threshold value, the processor 150 may determine that the alcohol sensor is located within the threshold driver exhalation area range.

According to an example, if it is determined that the alcohol sensor is located within the threshold driver exhalation area range, the processor 150 may determine the alcohol detection mode according to the setting mode of the driver, and detect alcohol in the determined alcohol detection mode to re-determine the drunken state of the driver.

if it is determined that the steering wheel is rotated and the amount of change in the steering angle exceeds a threshold, the processor 150 may determine that the alcohol sensor is not located within the threshold driver exhalation area range.

According to an example, if it is determined that the alcohol sensor is not located within the threshold driver exhalation area range, the processor 150 may determine an alcohol detection mode according to the setting mode of the driver, and detect alcohol in the determined alcohol detection mode to re-determine the drunken state of the driver (e.g., applying relaxed detection tolerance if in continuous mode).

In S310, the processor 150 may determine the alcohol detection mode as the third mode if the setting mode of the driver is the continuous measurement mode, and control the alcohol sensor and vehicle air conditioning to correspond to the third mode (e.g., relaxed alignment with moderate airflow control).

According to an example, if the alcohol sensor is not located within the threshold driver exhalation area range and the setting mode of the driver is the continuous measurement mode, the processor 150 may set the suction strength of the alcohol sensor to be “strong” and control the vehicle air conditioning to be “weak”. If the setting mode of the driver is the continuous measurement mode, the processor 150 may determine that alcohol measurement is attempted even if the alcohol sensor is not located in the normal measurement area, and may set the suction strength of the alcohol sensor to be “strong” and control the vehicle air conditioning to be “weak” such that alcohol measurement is easily performed (e.g., by compensating for poor breath direction or sensor misalignment) even if the alcohol sensor is not located in the normal measurement area.

If the setting mode of the driver is the precision measurement mode, in S320, the processor 150 may determine the alcohol detection mode as a fourth mode and control the sensor and vehicle air conditioning to correspond to the fourth mode (e.g., strict sensor location enforcement and airflow shutdown).

According to an example, if the alcohol sensor is not located within the threshold driver exhalation area range, and the setting mode of the driver is the precision measurement mode, the processor 150 may set the alcohol sensor to be “off” and control the vehicle air conditioning to maintain the previously set mode. If the setting mode of the driver is the precision measurement mode, the processor 150 may determine to attempt alcohol measurement only if the alcohol sensor is located within the threshold range, and because the alcohol sensor is not located required area, the alcohol sensor may be turned off and alcohol measurement may not be performed, so the vehicle air conditioning may be controlled in the preset mode (e.g., to avoid unnecessary changes to climate settings if measurement is paused).

The processor 150 may measure alcohol in the determined alcohol detection mode and determine whether to maintain driving based on the amount of alcohol detected. The processor 150 may determine the alcohol detection mode based on whether the sensor is located within the threshold driver exhalation area range periodically even after driving has started, measure alcohol, and determine whether to maintain driving, thereby fundamentally preventing drunk driving (e.g., enabling continuous safety monitoring during long trips or stop-and-go traffic).

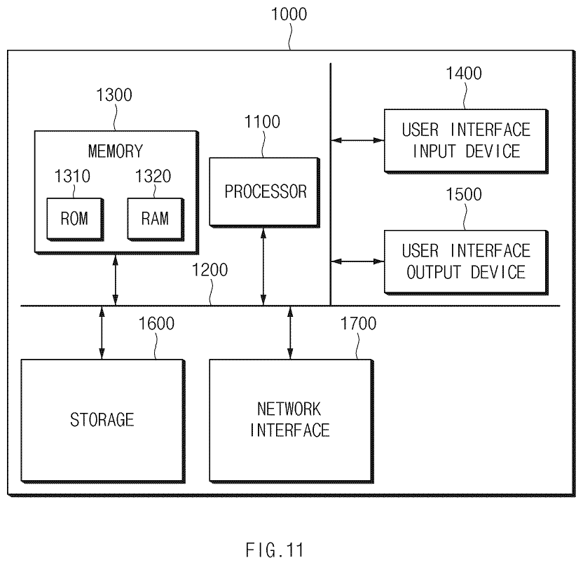

FIG. 11 shows an exemplary computing system for executing a method according to an example of the present disclosure.

Referring to FIG. 11, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320 (e.g., DRAM, SRAM, or LPDDR, etc.).

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a solid-state drive (SSD), a detachable disk, or a CD-ROM (e.g., DVD, Blu-ray disc, USB drive, or memory stick, etc.). The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal (e.g., a vehicle-mounted control circuitry or a mobile device, etc.). In another method, the processor and the storage medium may reside in the user terminal as an individual component.

One example of the present disclosure provides an apparatus and a method for controlling a vehicle capable of detecting the exhaled air of a driver only if an alcohol sensor is located in a normal measurement area, thereby determining whether the driver is drunk.

Another example of the present disclosure provides an apparatus and a method for controlling a vehicle capable of outputting a guidance message to allow an alcohol sensor to be located in a normal measurement area if the alcohol sensor is not located in the normal measurement area.

Another example of the present disclosure provides an apparatus and a method for controlling a vehicle capable of checking the drunken state of a driver if a preset time period elapses even after the driver is permitted to drive, thereby fundamentally blocking drunk driving.

The technical problems to be solved by the present disclosure are not limited to the aforementioned problems, and any other technical problems not mentioned herein will be clearly understood from the following description by those skilled in the art to which the present disclosure pertains.

According to one example of the present disclosure, an apparatus for controlling a vehicle includes a sensor installed on a steering wheel to detect alcohol included in exhaled air of a driver, and a processor that detects the alcohol and determines whether the driver is drunk if the sensor is located in a normal measurement area after the driver sits in a seat of the vehicle, determines an alcohol detection mode based on whether the sensor is located in the normal measurement area if the driver is determined not to be drunk and driving is permitted, and detects the alcohol in the determined alcohol detection mode and re-determines a drunken state of the driver.

According to an example, the processor may determine that the sensor is located in the normal measurement area if a steering angle change amount of the steering wheel does not exceed a threshold value.

According to an example, the processor may determine that the sensor is out of the normal measurement area when determining that the sensor is out of a preset exhalation area of the driver before the driving, and output a guidance message requesting an operation of the steering wheel to allow the sensor to be located within the normal measurement area.

According to an example, the processor may re-determine whether the sensor is located within the normal measurement area when the driving is permitted.

According to an example, the processor may determine the alcohol detection mode according to a setting mode of the driver if it is determined that the sensor is located within the normal measurement area after the driving is permitted, and detect the alcohol in the determined alcohol detection mode to re-determine the drunken state of the driver.

According to an example, the processor may determine the alcohol detection mode as a first mode if the setting mode of the driver is a continuous measurement mode, and control the sensor and vehicle air conditioning to correspond to the first mode.

According to an example, the processor may determine the alcohol detection mode as a second mode if the setting mode of the driver is a precision measurement mode, and control the sensor and vehicle air conditioning to correspond to the second mode.

According to an example, the processor may determine the alcohol detection mode according to a setting mode of the driver if it is determined that the sensor is out of the normal measurement area after the driving is permitted, and detect the alcohol in the determined alcohol detection mode to re-determine the drunken state of the driver.

According to an example, the processor may determine the alcohol detection mode as a third mode if the setting mode of the driver is a continuous measurement mode, and control the sensor and vehicle air conditioning to correspond to the third mode.

According to an example, the processor may determine the alcohol detection mode as a fourth mode if the setting mode of the driver is a precision measurement mode, and control the sensor and vehicle air conditioning to correspond to the fourth mode.

According to another example of the present disclosure, a method of controlling a vehicle includes detecting, by a processor, whether a driver is drunk based on alcohol detected by a sensor if the sensor provided in a steering wheel is located in a normal measurement area after the driver sits in a seat of the vehicle, determining an alcohol detection mode based on whether the sensor is located in the normal measurement area if the driver is determined not to be drunk and driving is permitted, and detecting the alcohol in the determined alcohol detection mode to re-determine a drunken state of the driver.

According to an example, the method may further include determining, by the processor, that the sensor is located in the normal measurement area if a steering angle change amount of the steering wheel does not exceed a threshold value.

According to an example, the method may further include determining, by the processor, that the sensor is out of the normal measurement area if determining that the sensor is out of a preset exhalation area of the driver before the driving, and outputting a guidance message requesting an operation of the steering wheel to allow the sensor to be located within the normal measurement area.

According to an example, the method may further include re-determining, by the processor, whether the sensor is located within the normal measurement area if the driving is permitted.

According to an example, the method may further include determining, by the processor, the alcohol detection mode according to a setting mode of the driver if it is determined that the sensor is located within the normal measurement area after the driving is permitted, and detecting the alcohol in the determined alcohol detection mode to re-determine the drunken state of the driver.

According to an example, the method may further include determining, by the processor, the alcohol detection mode as a first mode if the setting mode of the driver is a continuous measurement mode, and controlling the sensor and vehicle air conditioning to correspond to the first mode.

According to an example, the method may further include determining, by the processor, the alcohol detection mode as a second mode if the setting mode of the driver is a precision measurement mode, and controlling the sensor and vehicle air conditioning to correspond to the second mode.

According to an example, the method may further include determining, by the processor, the alcohol detection mode according to a setting mode of the driver if it is determined that the sensor is out of the normal measurement area after the driving is permitted, and detecting the alcohol in the determined alcohol detection mode to re-determine the drunken state of the driver.

According to an example, the method may further include determining, by the processor, the alcohol detection mode as a third mode if the setting mode of the driver is a continuous measurement mode, and controlling the sensor and vehicle air conditioning to correspond to the third mode.

According to an example, the method may further include determining, by the processor, the alcohol detection mode as a fourth mode if the setting mode of the driver is a precision measurement mode, and controlling the sensor and vehicle air conditioning to correspond to the fourth mode.

According to the examples of the present disclosure, the apparatus and the method for controlling a vehicle may detect the exhaled air of a driver only if the alcohol sensor is located in the normal measurement area, thereby accurately determining whether the driver is drunk.

According to the examples of the present disclosure, the apparatus and the method for controlling a vehicle may output the guidance message to allow the alcohol sensor to be located in the normal measurement area if the alcohol sensor is not located in the normal measurement area, thereby accurately determining whether the driver is drunk.

According to the examples of the present disclosure, the apparatus and the method for controlling a vehicle may check the drunken state of a driver if the preset time period elapses even after the driver is permitted to drive, thereby fundamentally blocking drunk driving.

Although examples of the present disclosure have been described for illustrative purposes, those skilled in the art will appreciate that various modifications, additions and substitutions are possible, without departing from the scope and spirit of the disclosure.

Therefore, the examples disclosed in the present disclosure are provided for the sake of descriptions, not limiting the technical concepts of the present disclosure, and it should be understood that such examples are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed:

1. An apparatus of a vehicle, the apparatus comprising:
a processor; and
a memory storing at least one instruction that, when executed by the processor communicating with the memory, is configured to cause the apparatus to:
detect, using a sensor installed on a steering wheel of the vehicle, an alcohol level associated with exhaled air of a driver of the vehicle,
determine, based on the detected alcohol level and the sensor being located within a threshold driver exhalation area range after the driver being seated in the vehicle, an intoxicated state of the driver,
determine an alcohol detection mode based on the intoxicated state of the driver indicating the driver not intoxicated and permitted to drive and based on whether the sensor being within the threshold driver exhalation area range,
detect, based on the determined alcohol detection mode, a second alcohol level associated with exhaled air of the driver, and
update, based on the detected second alcohol level, the intoxicated state of the driver.

2. The apparatus of claim 1, wherein the at least one instruction, when executed by the processor communicating with the memory, is configured to cause the apparatus to determine, based on a steering angle change amount of the steering wheel not exceeding a threshold value, that the sensor is located in the threshold driver exhalation area range.

3. The apparatus of claim 1, wherein the at least one instruction, when executed by the processor communicating with the memory, is configured to cause the apparatus to:
determine that the sensor is out of the threshold driver exhalation area range before the driver starts driving, and
output a guidance message requesting an operation of the steering wheel to allow the sensor to be located within the threshold driver exhalation area range.

4. The apparatus of claim 3, wherein the at least one instruction, when executed by the processor communicating with the memory, is configured to cause the apparatus to update the intoxicated state of the driver by re-determining whether the sensor is located within the threshold driver exhalation area range after the driving is permitted.

5. The apparatus of claim 1, wherein the at least one instruction, when executed by the processor communicating with the memory, is configured to cause the apparatus to:
determine, based on a setting mode of the driver, the alcohol detection mode.

6. The apparatus of claim 5, wherein the at least one instruction, when executed by the processor communicating with the memory, is configured to cause the apparatus to:
determine the alcohol detection mode as a first mode, based on the setting mode of the driver corresponding to a continuous measurement mode, and
control, based on the first mode, the sensor and air conditioning of the vehicle.

7. The apparatus of claim 5, wherein the at least one instruction, when executed by the processor communicating with the memory, is configured to cause the apparatus to:
determine the alcohol detection mode as a second mode, based on the setting mode of the driver corresponding to a precision measurement mode, and
control, based on the second mode, the sensor and air conditioning of the vehicle.

8. The apparatus of claim 4, wherein the at least one instruction, when executed by the processor communicating with the memory, is configured to cause the apparatus to:
based on a setting mode of the driver and the sensor being out of the threshold driver exhalation area range after the driving is permitted, determine the alcohol detection mode.

9. The apparatus of claim 8, wherein the at least one instruction, when executed by the processor communicating with the memory, is configured to cause the apparatus to:
determine the alcohol detection mode as a third mode, based on the setting mode of the driver corresponding to a continuous measurement mode, and
control, based on the third mode, the sensor and air conditioning of the vehicle.

10. The apparatus of claim 8, wherein the at least one instruction, when executed by the processor communicating with the memory, is configured to cause the apparatus to:
determine the alcohol detection mode as a fourth mode, wherein the setting mode of the driver corresponds to a precision measurement mode, and
control, based on the fourth mode, the sensor and air conditioning of the vehicle.

11. A method performed by a vehicle, the method comprising:
after a driver sitting in a seat of the vehicle, determining, based on an alcohol level detected by a sensor of the vehicle, an intoxicated state of the driver, wherein the sensor is installed on a steering wheel and located within a threshold driver exhalation area range;
determining, based on the intoxicated state of the driver indicating the driver not intoxicated and permitted to drive and based on whether the sensor being located within the threshold driver exhalation area range, an alcohol detection mode;
detecting, based on the determined alcohol detection mode, a second alcohol level associated with exhaled air of the driver; and
updating, based on the detected second alcohol level, the intoxicated state of the driver.

12. The method of claim 11, further comprising:
determining, based on a steering angle change amount of the steering wheel not exceeding a threshold value, that the sensor is located in the threshold driver exhalation area range.

13. The method of claim 11, further comprising:
determining that the sensor is out of the threshold driver exhalation area range before the driver starts driving, and
outputting a guidance message requesting an operation of the steering wheel to allow the sensor to be located within the threshold driver exhalation area range.

14. The method of claim 13, wherein the updating of the intoxicated state of the driver comprises:
re-determining whether the sensor is located within the threshold driver exhalation area range after the driving is permitted.

15. The method of claim 11, wherein the determining of the alcohol detection mode comprises:
determining, based on a setting mode of the driver, the alcohol detection mode.

16. An apparatus of a vehicle, the apparatus
comprising:
a processor; and
a memory storing at least one instruction that, when executed by the processor communicating with the memory, is configured to cause the apparatus to:
determine, based on a driver sitting in a seat of the vehicle and a driver-selected setting mode, whether an alcohol sensor of the vehicle is positioned within a predetermined breath sensing region,
control, based on the driver-selected setting mode and whether the alcohol sensor of the vehicle is positioned within the predetermined breath sensing region, one or more operating parameters of the alcohol sensor,
detect an alcohol level associated with exhaled air of the driver using the alcohol sensor with the controlled operating parameters,
output, based on the detected alcohol level, a signal indicating a state of the driver, and
control, based on the signal, operation of the vehicle.

17. The apparatus of claim 16, wherein the at least one instruction, when executed by the processor communicating with the memory, is configured to cause the apparatus to:
determine that the alcohol sensor is positioned within the predetermined breath sensing region and that the driver-selected setting mode corresponds to a first detection mode, and
control a suction strength of the alcohol sensor and an air conditioning of the vehicle to maintain respective previously set configurations for alcohol detection.

18. The apparatus of claim 16, wherein the at least one instruction, when executed by the processor communicating with the memory, is configured to cause the apparatus to:
determine that the alcohol sensor is positioned within the predetermined breath sensing region and that the driver-selected setting mode corresponds to a second detection mode,
control the alcohol sensor to increase a suction strength of the alcohol sensor for alcohol detection, and
shut off an air conditioning of the vehicle for alcohol detection.

19. The apparatus of claim 16, wherein the at least one instruction, when executed by the processor communicating with the memory, is configured to cause the apparatus to:
determine that the alcohol sensor is not positioned within the predetermined breath sensing region and that the driver-selected setting mode corresponds to a third detection mode,
control the alcohol sensor to increase a suction strength of the alcohol sensor for alcohol detection, and
control an air conditioning of the vehicle to reduce an airflow output of the air conditioning for alcohol detection.

20. The apparatus of claim 16, wherein the at least one instruction, when executed by the processor communicating with the memory, is configured to cause the apparatus to:
determine that the alcohol sensor is not positioned within the predetermined breath sensing region and that the driver-selected setting mode corresponds to a fourth detection mode, and
disable the alcohol sensor and control an air conditioning of the vehicle to maintain a previously set airflow output of the air conditioning such that alcohol detection is deferred until the alcohol sensor is subsequently positioned within the predetermined breath sensing region.
